(19) United States
(12) Patent Application Publication
(10) Pub. No.: US 2022/0215851 A1
(43) Pub. Date: Jul. 7, 2022

(54) DATA CONVERSION LEARNING DEVICE, DATA CONVERSION DEVICE, METHOD, AND PROGRAM

(71) Applicant: NIPPON TELEGRAPH AND TELEPHONE CORPORATION, Tokyo (JP)

(72) Inventors: Hirokazu KAMEOKA, Tokyo (JP); Takuhiro KANEKO, Tokyo (JP); Ko TANAKA, Tokyo (JP)

(73) Assignee: NIPPON TELEGRAPH AND TELEPHONE CORPORATION, Tokyo (JP)

(21) Appl. No.: 17/427,157

(22) PCT Filed: Jan. 31, 2020
(86) PCT No.: PCT/JP2020/003691

§ 371 Date: Feb. 23, 2022

(30) Foreign Application Priority Data
Feb. 1, 2019 (JP) 2019-016909

(51) Int. Cl. G10L 21/007; G10L 25/30

(52) U.S. Cl. CPC G10L 21/007; G10L 25/30

(57) ABSTRACT

The present invention realizes conversion into data having a desired attribute. A training unit 32 trains a converter so as to minimize the value of a learning criterion for the converter, and trains an integrated discriminator so as to minimize the value of a learning criterion for the integrated discriminator.

### TECHNICAL FIELD

The present invention relates to a data conversion training apparatus, a data conversion apparatus, a method, and a program, and particularly relates to a data conversion training apparatus, a data conversion apparatus, a method, and a program that are used to convert data.

### BACKGROUND ART

Star Generative Adversarial Network (StarGAN) is a neural network model that aims to convert data such as images and sounds so as to have different attributes (styles) while preserving the contents thereof, and a method for training such a neural network model, and mainly characterized in that training can be performed using unpaired data, and that mutual conversion between various attributes can be performed using one model.

According to StarGAK, a converter G that outputs data y of an attribute class k upon input data (e.g. an image) x and a target attribute label being input thereto is modeled using a neural network, and the converter G is trained using

{xₘ,cₘ}ₘ₌₁^{M}

that is training data having various attributes. Here, an aim is to generate the converted data

ŷ=G(x,k)

so as to be like real data, and so as to be like data having the attribute k. The converter G is trained using a discriminator D that discriminates between real data and synthetic data, and an attribute discriminator C that discriminates between attributes. First, the loss function of the discriminator D when the cross entropy criterion is used can be written as

[symbol]

adv(D,G)=− [symbol] _{k˜p(k),y˜pdata(y|k)}[log D(y)]− [symbol] _{k˜p(k),x˜pdata(x)}[log(1−D(G(x,k)))] (1)

Formula (1) is a criterion that takes a small value when the discriminator D identifies y as real data, and correctly identifies

ŷ=G(x,k)

as synthetic data. Therefore, the discriminator D aims to reduce this value. On the other hand, the first object of the converter G is to generate data

G(x,k)

so as to be high quality data that cannot be identified as synthetic data by the discriminator D. Therefore, the converter G aims to increase this value. The second object of the converter G is to convert x so that

G(x,k)

becomes like data having the attribute k. To achieve this aim, loss functions such as

[symbol]

_{cls}^{r}(C)=− [symbol] _{k˜p(k),y˜pdata(y|k)}[log pc(k|y)] (2)

[symbol]

_{cls}^{f}(G)=− [symbol] _{k˜p(k),x˜pdata(x)}[log pc(k|G(x,k))] (3)

are employed as criteria. Formula (2) is a criterion that takes a small value when the attribute discriminator C correctly identifies real data having the attribute k as data having the attribute k. Therefore, the attribute discriminator C aims to reduce this value. Or the other hand, the second object of the converter G is to generate

G(x,c)

so as to be identified as data having the attribute k by the attribute discriminator C. Therefore, the converter G aims to reduce the value of Formula (3).

### CITATION LIST

### Non Patent Literature

[NPL 1] “Converting impression and intelligibility of speech”, NTT Communication Science Laboratories, Distributed Booklet for Open House 2018, P37

### SUMMARY OF THE INVENTION

### Technical Problem

If the converter G is trained only using the above-described criteria, it is not ensured that x and

G(x,k)

become the same data with the same content (the content of a speech in the case of a voice). Therefore, a loss function

[symbol]

_{cyc}(G)= [symbol] _{k′˜p(k),x˜pdata(x|k′),k˜p(k)}[∥x−G(G(x,k),k′)∥₁] (4)

that is called a circular consistency criterion, is employed.

G(G(x,k),k′)

represents data generated by re-converting

G(x,k)

that has been converted from a sample x having an attribute k′ into data having an attribute k, so as to be data having the attribute k′, and Formula (4) is a criterion that takes a smaller value as

G(G(x,k),k′)

becomes closer to the conversion source x. The third object of the converter G is to reduce this value. When taken together, the respective learning criteria for the converter G, the discriminator D, and the attribute discriminator C are

[symbol]

_{G}(G)=− [symbol] _{adv}(D,G)+λ_{cls} [symbol] _{cls}^{f}(G)+λ_{cyc} [symbol] _{cyc}(G) (5)

[symbol]

_{D}(D)= [symbol] _{adv}(D,G) (6)

[symbol]

_{C}(C)= [symbol] _{cls}^{r}(C) (7)

and a method for training the converter G, the discriminator D, and the attribute discriminator C so as to reduce the values of the criteria is StarGAN.

This method is characterized in that it is possible to perform training using unpaired pieces of data whose contents are not necessarily the same, and that it is possible to perform mutual conversion between various attributes, using one model. On the other hand, according to this method, it is not ensured that the converter is trained so that the converted data matches the distribution of pieces of data having the target attribute, and whether or not the converter will be able to perform appropriate conversion into data having a designated attribute depends on the design of the network architecture.

The present invention has been made to solve the above-described problems, and aims to provide a data conversion training apparatus, a method, and a program that are capable of training a converter that can perform conversion into data having a desired attribute.

The present invention also aims to provide a data conversion apparatus that is capable of performing conversion into data having a desired attribute.

### Means for Solving the Problem

To achieve the aim, a data conversion training apparatus according to a first aspect includes a training unit that trains a converter that converts conversion source data into data having an attribute indicated by an attribute code, using the conversion source data and the attribute code as an input, based on pieces of conversion source data having different attributes and attribute codes indicating attributes of the pieces of conversion source data, the training unit training the converter so as to minimize a value of a learning criterion represented using: regarding data converted by the converter using a given attribute code as an input, a degree of likeness to the given attribute code and a degree of likeness to converted data discerned by an integrated discriminator that discerns a degree of likeness to real data and an attribute code, and a degree of likeness to converted data; and a difference between data re-converted by the converter, using an attribute code of conversion source data as an input, from data converted by the converter, using an attribute code different from an attribute code of the conversion source data as an input, and the conversion source data, and the training unit training the integrated discriminator so as to minimize a value of a learning criterion represented using: a degree of likeness to converted data, discerned by the integrated discriminator, regarding data converted by the converter using a given attribute code as an input; and a degree of likeness to an attribute code of the conversion source data, discerned by the integrated discriminator, regarding the conversion source data.

A data conversion training method according to a second aspect includes: by using a training unit, training a converter that converts conversion source data into data having an attribute indicated by an attribute code, using the conversion source data and the attribute code as an input, based on pieces of conversion source data having different attributes and attribute codes indicating attributes of the pieces of conversion source data, wherein the converter is trained so as to minimise a value of a learning criterion represented using: regarding data converted by the converter using a given attribute code as an input, a degree of likeness to the given attribute code and a degree of likeness to converted data discerned by an integrated discriminator that discerns a degree of likeness to real data and an attribute code, and a degree of likeness to converted data; and a difference between data re-converted by the converter, using an attribute code of conversion source data as an input, from data converted by the converter, using an attribute code different from an attribute code of the conversion source data as an input, and the conversion source data, and the integrated discriminator is trained so as to minimize a value of a learning criterion represented using: a degree of likeness to converted data, discerned by the integrated discriminator, regarding data converted by the converter using a given attribute code as an input; and a degree of likeness to an attribute code of the conversion source data, discerned by the integrated discriminator, regarding the conversion source data.

A data conversion apparatus according to a third aspect includes: a data conversion unit that estimates target data, from input conversion source data and an attribute code indicating an attribute of the target data, using a converter that uses data and an attribute code as an input to convert the data to data having the attribute indicated by the attribute code, wherein the converter is trained in advance based on pieces of conversion source data having different attributes and attribute codes indicating attributes of the pieces of conversion source data, so as to minimize a value of a learning criterion represented using: regarding data converted by the converter using a given attribute code as an input, a degree of likeness to the given attribute code and a degree of likeness to converted data discerned by an integrated discriminator that discerns a degree of likeness to real data and an attribute code, and a degree of likeness to converted data; and a difference between data re-converted by the converter, using an attribute code of conversion source data as an input, from data converted by the converter, using an attribute code different from an attribute code of the conversion source data as an input, and the conversion source data, and the integrated discriminator is trained in advance so as to minimize a value of a learning criterion represented using: a degree of likeness to converted data, discerned by the integrated discriminator, regarding data converted by the converter using a given attribute code as an input; and a degree of likeness to an attribute code of the conversion source data, discerned by the integrated discriminator, regarding the conversion source data.

A program according to a fourth aspect is a program for causing a computer to train a converter that converts conversion source data into data having an attribute indicated by an attribute code, using the conversion source data and the attribute code as an input, based on pieces of conversion source data having different attributes and attribute codes indicating attributes of the pieces of conversion source data, wherein the converter is trained so as to minimize a value of a learning criterion represented using: regarding data converted by the converter, using a given attribute code as an input, a degree of likeness to the given attribute code and a degree of likeness to converted data discerned by an integrated discriminator that discerns a degree of likeness to real data and an attribute code, and a degree of likeness to converted data; and a difference between data re-converted by the converter, using an attribute code of conversion source data as an input, from data converted by the converter, using an attribute code different from an attribute code of the conversion source data as an input, and the conversion source data, and the integrated discriminator is trained so as to minimize a value of a learning criterion represented using: a degree of likeness to converted data, discerned by the integrated discriminator, regarding data converted by the converter using a given attribute code as an input; and a degree of likeness to an attribute code of the conversion source data, discerned by the integrated discriminator, regarding the conversion source data.

### Effects of the Invention

With the data conversion training apparatus, the method, and the program according to the aspects of the present invention, it is possible to achieve the effect of realizing training of a converter so that the converter can perform conversion into data having a desired attribute.

With the data conversion apparatus according to one aspect of the present invention, it is possible to achieve the effect of realizing conversion into data having a desired attribute.

### BRIEF DESCRIPTION OF DRAWINGS

FIG. 1 is a block diagram showing a configuration of a data conversion training apparatus according to an embodiment of the present invention.

FIG. 2 is a block diagram showing a configuration of a data conversion apparatus according to an embodiment of the present invention.

FIG. 3 is a schematic block diagram showing an example of a computer that functions as a data conversion training apparatus or a data conversion apparatus.

FIG. 4 is a flowchart showing a data conversion training processing routine for a data conversion training apparatus according to an embodiment of the present invention.

FIG. 5 is a flowchart showing a data conversion processing routine for a data conversion apparatus according to an embodiment of the present invention.

FIG. 6 is a diagram showing a network configuration of a converter.

FIG. 7 is a diagram showing a network configuration of an integrated discriminator.

### DESCRIPTION OF EMBODIMENTS

The following describes an embodiment of the present invention with reference to the drawings.

### Outline of Embodiment of Present Invention

First/an outline of an embodiment of the present invention will be described.

Star Generative Adversarial Network (StarGAN) according to an embodiment of the present invention is a neural network model that aims to convert data such as images and sounds so as to have different attributes (styles) while preserving the contents thereof and a method for training such a neural network model, and is mainly characterized in that training can be performed using unpaired data, and that mutual conversion between various attributes can be performed using one model. On the other hand, it is not ensured that the converter is trained so that the converted data matches the distribution of pieces of data having the target attribute, and whether or not the converter will be able to perform appropriate conversion largely depends on the design of the network architecture. Modified Star Generative Adversarial Networks (mStarGAN) proposed in the present embodiment is a method improved in this point to train a converter so that the converted data matches the distribution of pieces of data having the target attribute.

The Modified Star Generative Adversarial Networks (mStarGAN) proposed in the present embodiment is characterized by 1. to 3. shown below.

1. A multi-class classifier (hereinafter referred to as integrated discriminator D) that is formed by integrating a fake data discriminator and an attribute discriminator, and that considers whether or not data is synthetic data as one of the attributes, is used instead of the fake data discriminator and the attribute discriminator.

2. A converter G is trained such that an output from the converter G

G(x,k)

is to be correctly identified as data having a target attribute k, and is not to be detected as synthetic data, by the integrated discriminator.

3. By improving the StarGAN so that the integrated discriminator D is trained so as to correctly discern real data having the attribute k as data having the attribute k, and correctly discern

G(x,k)

as synthetic data, the converter can be trained such that the converted data matches the distribution of pieces of data having the target attribute.

### Principles of Embodiment of Present Invention

### Formulation of Embodiment of Present Invention

x˜pdata(x)

denotes pieces of real data having a given attribute. Each piece of real data belongs to any one of attribute classes k=1, . . . , K, and an attribute class k=K+1 is defined as an attribute that indicates synthetic data, which is fake data. A one-hot vector that represents an attribute class is referred to as an attribute code, and is denoted as c. An object of the integrated discriminator D is to correctly discern an output

G(x,k)

from the converter G as data of a fake class, and real data

y˜pdata(y|k)

having the attribute k ∈ {1, . . . , K} as data of the class k. Therefore, for example,

V(D)=− [symbol] _{k˜p(k),y˜pdata(y|k)}[log pD(k≡1y)]− [symbol] _{k˜p(k),x˜pdata(x)}[log pD(K+1|G(x,k))] (8)

can be defined as learning criteria for the integrated discriminator D. However, an output

PD(k|y)

from the integrated discriminator D represents the probability that the input y belongs to the class k. The first term of Formula (8) is a criterion that takes a small value when the integrated discriminator D assigns a high probability to the attribute k with respect to real data having the attribute k, i.e., when the integrated discriminator D can correctly discern the data as data having the attribute k. The second term of Formula (8) is a criterion that takes a small value when the integrated discriminator D can discern data converted into data having any attribute as data of a fake class.

On the other hand, an object of the converter G is to generate data

G(x,k)

so as to be correctly identified as data having the target attribute k, and so as not to be identified as false data, by the integrated discriminator D. Therefore, for example,

I(G)=− [symbol] _{c˜p(k),x˜pdata(x)}[log pD(k|G(x,k))]+ [symbol] _{c˜p(k),x˜pdata(x)}[log pD(K+1|G(x,k))] (9)

can be defined as learning criteria for the converter G. The first term of Formula (9) is a criterion that takes a small value when

G(x,k)

is identified by as data having the attribute k the integrated discriminator D, and the second term is a criterion that takes a large value when

G(x,k)

is identified as data of a fake class Kby the integrated discriminator D.

In the case of the method according to an embodiment of the present invention, as in the case of the StarGAN,

[symbol]

_{cyc}(G)= [symbol] _{k′˜p(k),x˜pdata(x|k′),c˜p(k)}[∥x−G(G(x,k),k′)∥_{ρ}] (10)

is included in the learning criteria for the converter G in addition to the above-descried criteria. In addition to the criterion, it is possible to also include an identity mapping criterion that takes a smaller value as data G(x,k) converted from real data

x˜pdata(x|k)

having the attribute k, using the same attribute k as the target attribute, becomes closer to the conversion source data x, where the identity mapping criterion is represented as

[symbol]

_{rec}(G)= [symbol] _{k˜p(k),x˜pdata(x|k)[∥x-G(x,k)}∥_{ρ}] (11)

When taken together, the respective learning criteria for the converter G and the integrated discriminator D are

[symbol]

_{G}(G)=I(G)+λ_{cyc} [symbol] _{cyc}(G)+λ_{rec} [symbol] _{rec}(G) (12)

and

[symbol]

_{D}(D)=V(D) (13)

and a method for training the converter G and the integrated discriminator D so as to reduce them is the mStacGAN of the method according to an embodiment of the present invention.

<Optimal Solution To Training Problem>

The following description shows that, when

λ_{cyc}=λ_{rec}=0

is satisfied in Formula (12), the optimal solution to the above-described training problem coincides with the case in which the distribution of

G(x,k)

and

Pdata(y|k)

match with each other. First, regarding a given converter G, a solution for the integrated discriminator D that minimizes Formula (13) is calculated. When the variables are changed according to

y=G(x,k)˜p_{G}(y)

Formula (8) can be rewritten as

V(D)−− [symbol] _{k˜p(k),y˜pdata(y|k)}[log pD(k|y)]− [symbol] _{k˜p(k),y˜pG(y)}[log p_{D}(K+1|y)] (14)

and therefore Formula (14) is minimized under the limitation represented as

Σₖp_{D}(k|y)=1

Here,

P_{D}(k|y)

is calculated as follows, using the method of Lagrange multipliers.

$$\begin{matrix}\hat{{p}_{D}} ( k \vert y ) = \frac{p ( k ) {p}_{data} ( y \vert k )}{{\sum }_{k} p ( k ) {p}_{data} ( y \vert k ) + {\sum }_{k} p ( k ) {p}_{G} ( y \vert k )} \\ ( k = 1 , … , K ) & ( 15 ) \\ \hat{{p}_{D}} ( K + 1 \vert y ) = \frac{p ( k ) {p}_{G} ( y \vert k )}{{\sum }_{k} p ( k ) {p}_{data} ( y \vert k ) + {\sum }_{k} p ( k ) {p}_{G} ( y \vert k )} & ( 16 )\end{matrix}$$

Next, by assigning Formula (9) to Formulas (15) and (16),

$$\begin{matrix}I ( G ) = - {𝔼}_{i ∼ p ( k ) , y ∼ {p}_{G} ( y \vert k )} [ log \begin{matrix}\frac{p ( k ) {p}_{data} ( y \vert k )}{{\sum }_{k} p ( k ) {p}_{data} ( y \vert k ) + {\sum }_{k} p ( k ) {p}_{G} ( y \vert k )} \\ \frac{{\sum }_{k} p ( k ) {p}_{data} ( y \vert k ) + {\sum }_{k} p ( k ) {p}_{G} ( y \vert k )}{p ( k ) {p}_{G} ( y \vert k )}\end{matrix} ] \\ = - {𝔼}_{k ∼ p ( k ) , y ∼ {p}_{G} ( y \vert k )} [ log \frac{{p}_{data} ( y \vert k )}{{p}_{G} ( y \vert k )} ] \\ = {𝔼}_{k ∼ p ( k )} KL [ {p}_{G} ( y \vert k ) \vert \vert {p}_{data} ( y \vert k ) ]\end{matrix} \qquad ( 17 )$$

is obtained. Thus, it can be seen that 1(G) under the optimal integrated discriminator D coincides with the Kullback-Leibler divergence of

pG(y|k)

and

Pdata(y|k).

Thus, the above-described method for training the integrated discriminator D and the converter G can be interpreted as distribution fitting.

### Configuration of Data Conversion Training Apparatus According to Embodiment of Present Invention

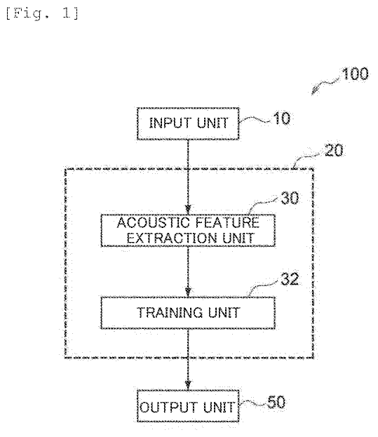

Next, a configuration of a data conversion training apparatus according to an embodiment of the present invention will be described. As shown in FIG. 1, a data conversion training apparatus 100 according to an embodiment of the present invention can be formed using a computer that includes a CPU, a RAM, and a ROM that stores programs for executing data conversion training processing routines described below and various kinds of data. As shown in FIG. 1, in terms of functionality, the data conversion training apparatus 100 includes an input unit 10, a computation unit 20, and an output unit 50.

The input, unit 10 receives, as inputs, conversion source voice signals having different attributes, and attribute codes that indicate the respective attributes of the conversion source voice signals. Note that the attribute codes indicating the attributes of the conversion source voice signals may be manually given. The attributes of voice signals include, for example, a gender, adult/child, a speaker ID, whether or not the speaker is a native speaker (origin), the type of speech mood (anger, sadness, etc.), a speech mode (a lecture-like mode, free speech-like mode, etc.).

The computation unit 20 includes an acoustic feature extraction unit 30 and a training unit 32.

The acoustic feature extraction unit 30 extracts a series of acoustic features from conversion source voice signals that have been input.

Based on a series of acoustic features of conversion source voice signals and attribute codes that indicate the attributes of the conversion source voice signals, the training unit 32 trains a converter that receives a series of acoustic features and attribute codes as inputs and converts the series of acoustic features into a series of acoustic features of voice signals that have the attributes indicated by the attribute codes.

Specifically, the training unit 32 trains the converter so as to minimize the value of the learning criterion represented by Formula (12) described above. This learning criterion is represented using: a degree of likeness to a given attribute code and a degree of likeness to a converted voice discerned by an integrated discriminator that discerns a degree of likeness to a real voice and an attribute code, and a degree of likeness to a converted voice, regarding a series of acoustic features converted by the converter, using a given attribute code as an input; the difference between a series of acoustic features re-converted by the converter, using an attribute code of a series of acoustic features of a conversion source voice signal as an input, from a series of acoustic features converted by the converter, using an attribute code different from the attribute code of the series of acoustic features of the conversion source voice signal as an input, and the series of acoustic features of the conversion source voice signal; and the distance between the series of acoustic features of the voice signal converted by the converter using the attribute code of the series of acoustic features of the conversion source voice signal as an input, and the series of acoustic features of the conversion source voice signal.

The training unit 32 also trains the integrated discriminator so as to minimize the value of the learning criterion represented by Formula (13) described above. This learning criterion is represented using: a degree of likeness to voice, discerned by the integrated discriminator, regarding the series of acoustic features converted by the converter using a given attribute code as an input; and a degree of likeness to an attribute code of the series of acoustic features of the conversion source voice signal, discerned by the integrated discriminator, regarding the series of acoustic features of the conversion source voice signal.

The training unit 32 repeats the training of the above-described converter and the training of the integrated discriminator alternatingly until a predetermined termination condition is satisfied, and outputs the ultimately obtained converter, using the output unit 50. Here, the converter and the integrated discriminator are formed using a convolutional network or a recurrent network.

### Configuration of Data Conversion Apparatus According to Embodiment of Present Invention

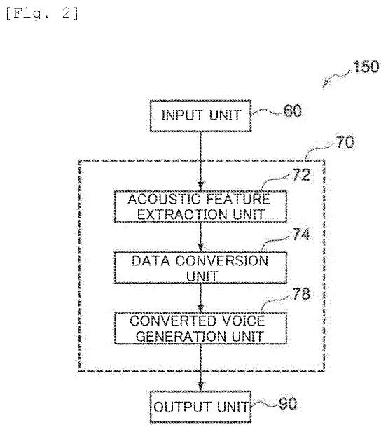

Next, a configuration of a data conversion apparatus according to an embodiment of the present invention will be described. As shown in FIG. 2, a data conversion apparatus 150 according to an embodiment of the present invention can be formed using a computer that includes a CPU, a RAM, and a ROM that stores programs for executing data conversion training processing routines described below and various kinds of data. As shown in FIG. 2, in terms of functionality, the data conversion apparatus 150 includes an input unit 60, a computation unit 70, and an output unit 90.

The input unit 60 receives, as inputs, conversion source voice signals h, and attribute codes that indicate the respective attributes of the target voice signals. Note that the attribute codes indicating the attributes of the target voice signals may be manually given.

The computation unit 70 includes an acoustic feature extraction unit 72, a data conversion unit 74, and a converted voice generation unit 78.

The acoustic feature extraction unit 72 extracts a series of acoustic features from conversion source voice signals that have been input.

The data conversion unit 74 estimates a series of acoustic features of the target voice signal from the series of acoustic features extracted by the acoustic feature extraction unit 72 and the attribute code received by the input unit 60, using the converter trained by the data conversion training apparatus 100.

The converted voice generation unit 78 generates a time domain signal from the series of acoustic features of the estimated target voice signal, and outputs it as a target voice signal, using the output unit 90.

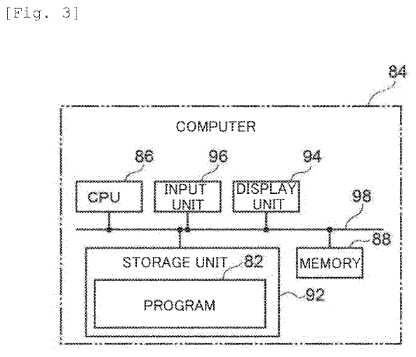

The data conversion training apparatus 100 and the data conversion apparatus 150 are each realized using a computer 84 shown in FIG. 3, for example. The computer 84 includes a CPU 86, a memory 88, a storage unit 92 that stores a program 82, a display unit 94 that includes a monitor, and an input unit 96 that includes a keyboard and a mouse. The CPU 86, the memory 88, the storage unit 92, the display unit 94, and the input unit 96 are connected to each other via a bus 98.

The storage unit 92 is realized using an HDD, an SSD, a flash memory, or the like. The storage unit 92 stores the program 82 for enabling the computer 64 to function as the data conversion training apparatus 100 or the data conversion apparatus 150. The CPU 86 reads out the program 82 from the storage unit 92, loads the program 82 to the memory 88, and executes the program 82. Note that the program 82 may be stored in a computer-readable medium and provided.

### Actions of Data Conversion Training Apparatus According to Embodiment of Present Invention

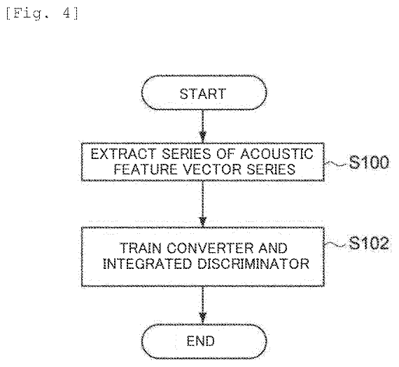

Next, actions of the data conversion training apparatus 100 according to an embodiment of the present invention will be described. Upon the input unit 10 receiving conversion source voice signals that have different attributes, and attribute codes that indicate the attributes of the conversion source voice signals, the data conversion training apparatus 100 executes data conversion training processing routine that is shewn in FIG. 4.

First, in step S100, a series of acoustic features are extracted from conversion source voice signals that have been input.

Next, in step S102, the converter and the integrated discriminator are trained based on a series of acoustic features of conversion source voice signals and attribute codes that indicate the attributes of the conversion source voice signals, the results of training are output from the output unit 50, and the data conversion training processing routine is terminated.

### Actions of Data Conversion Apparatus According to Embodiment of Present Invention

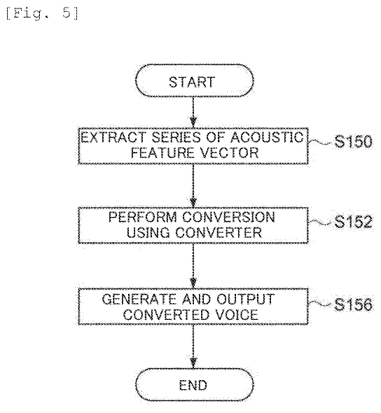

Next, actions of the data conversion apparatus 150 according to an embodiment of the present invention will be described. The input unit 60 receives the results of training performed by the data conversion training apparatus 100. Upon the input unit 60 receiving the conversion source voice signals and the attribute code that indicates the target attribute of voice signals the data conversion apparatus 150 executes the data conversion processing routine shown in FIG. 5.

First in step S150, a series of acoustic features are extracted from conversion source voice signals that have been input.

Next, in step S152, a series of acoustic features of the target voice signal are estimated from the series of acoustic features extracted by the acoustic feature extraction unit 72 and the attribute code received by the input unit 60, using the converter trained by the data conversion training apparatus 100.

In step S156, a time domain signal is generated from the series of acoustic features of the estimated target voice signal, is output as a target voice signal, using the output unit 90, and the data conversion processing routine is terminated.

### Experimental Results

In order to confirm the data conversion effect of the method according to the embodiment of the present invention, a speaker characteristic conversion experiment was conducted, using voice data of four speakers (a female speaker VCC2SF1, a male speaker VCC2SM1, a female speaker VCC2SF2, and a male speaker VCC2SM2) of Voice Conversion Challenge (VCC) 2018. Here, a four-dimensional one-hot vector that corresponds to a speaker ID is used as an attribute code. For each speaker, 81 sentences were used as learning data, 35 sentences were used as test data, and the sampling frequency of all voice signals was 16000 Hz. For each speech, a spectral envelope, a fundamental frequency (F₀), and an aperiodicity index were extracted through WORLD analysis, and 35th-order mel-cepstral analysis was performed on the extracted series of spectral envelopes. Regarding F₀, an average m_{arc} and a standard deviation σ_{arc} of a logarithm F₀, in the voiced section were calculated from training data for the conversion target voice, and an average m_{trg} and a standard deviation σ_{sfc} of the logarithm F₀ in the voiced section were calculated from training data for the conversion source voice. Also, a pattern y(0), . . . , y(N−1) of the logarithm F₀ of the input voice was converted as represented by

$$\hat{y} ( n ) = \frac{{σ}_{trg}}{{σ}_{src}} ( y ( n ) - {m}_{src} ) + {m}_{trg} \qquad ( 18 )$$

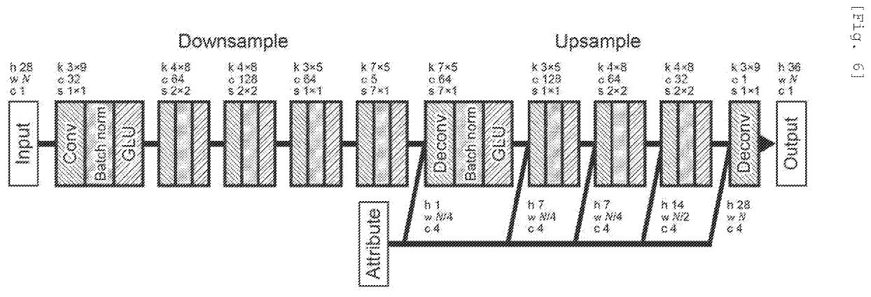

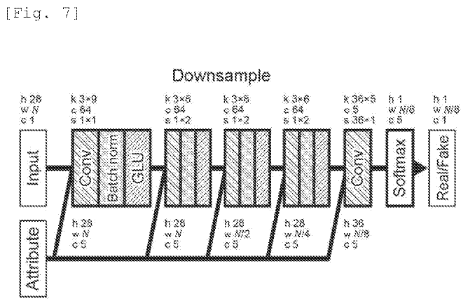

In this experiment, the method according to the embodiment of the present invention was used, the network configuration of the converter was set as shown in FIG. 6, and the network configuration of the integrated discriminator was set as shown in FIG. 7. When compared with the results of voice conversion performed using a conventional StarGAN that employs network configurations that are almost equivalent to the above-described configurations, it was auditorily confirmed that, with the method according to the embodiment of the present invention, it is possible to achieve higher quality and conversion effect.

Here, in FIGS. 6 and 7 mentioned above, “c”, “h”, and “w” respectively represent a channel, height, and width when inputs and outputs to and from the converter and inputs and outputs to and from the integrated discriminator are regarded as images. “Conv”, “Batch norm”, “GLU”, “Deconv”, and “Softmax” respectively represent a convolutional layer, a batch regularization layer, a linear unit with a gate, a transposed convolutional layer, and a softmax layer, “k”, “c”, and “s” in the convolution layer or the transposed convolution layer respectively represent the kernel size, the number of output channels, and the stride width.

As described above, the data conversion training apparatus according to the embodiment of the present invention is as follows.

A converter is trained so as to minimize the value of a learning criterion. Here, as described next, the learning criterion is represented by using the degree of likeness to a given attribute code and a degree of likeness to a converted voice, and a difference between a re-converted voice signal and a conversion source voice signal. Here, the degree of likeness to a given attribute code and the degree of likeness to a converted voice are discerned by the integrated discriminator. Regarding data converted by the converter using a given attribute code as an input, the integrated discriminator discerns the degree of likeness to a real voice and an attribute code and the degree of likeness to a converted voice. The above-described re-converted voice signal is a voice signal re-converted by the converter, using an attribute code of conversion source voice signal as an input, from a voice signal converted by the converter, using an attribute code different from the attribute code of the conversion source voice signal as an input.

Also, as described next, the data conversation training apparatus trains the integrated discriminator so as to minimize the value of a learning criterion represented using the degree of likeness to a converted voice and the degree of likeness to the attribute code of a conversion source voice signal. Here, the degree of likeness to a converted voice is discerned by the integrated discriminator regarding the voice signal converted by the converter, using a given attribute code as an input. The aforementioned degree of likeness to the attribute code of the conversion source voice signal is discerned by the integrated discriminator. Thus, it is possible to train a converter so as to be able to perform conversion into a voice signal that has a desired attribute.

The data conversion apparatus according to the embodiment of the present invention convers a voice signal using the converter described next. The converter is as described above trained in advance so as to minimize the learning the value of a learning criterion represented using the degree of likeness to a given attribute code and the degree of likeness to a converted voice and the difference between the reconverted voice signal and the conversion source voice signal. Here, the degree of likeness to a given attribute code and the degree of likeness to a converted voice are discerned by the integrated discriminator. Here regarding the voice signal converted by the converter using a given attribute code as an input, the integrated discriminator discerns the degree of likeness to a real voice and the attribute code and the degree of likeness to a converted voice based on conversion source voices having different attributes and attribute codes indicating the attributes of the conversion source voices. The re-converted voice signal is a voice signal re-converted by the converter using an attribute code of conversion source voice signal as an input, from a voice signal converted by the converter, using an attribute code different from the attribute code of the conversion source voice signal as an input. Thus, it is possible to perform conversion into a voice signal that has a desired attribute.

Note that the present invention is not limited to the above-described embodiment, and various modifications and applications may be employed without departing from the spirit of the present invention.

For example, although the data conversion training apparatus and the data conversion apparatus in the above-described embodiment are configured as separate apparatuses, they may be configured as one apparatus.

Also, although an example in which the data to be converted is a series of acoustic features of a voice signal is described above, the present invention is not limited to such an example, and the data to be converted may be a feature or a series of features of an image, a video, a text, or the like.

Also, although the above-described data conversion training apparatus and data conversion apparatus have a computer system inside, if a WWW system is employed, the “computer system” includes a homepage providing environment. (or display environment).

Also, although an embodiment in which the program is pre-installed is described in the description of the present application, it is also possible to provide the program by storing it on a computer-readable recording medium.

### REFERENCE SIGNS LIST

10, 60 Input unit
20, 70 Computation unit
30 Acoustic feature extraction unit
32 Training unit
50, 90 Output unit
72 Acoustic feature extraction unit
74 Data conversion unit
78 Converted voice generation unit
82 Program
84 Computer
100 Data conversion training apparatus
150 Data conversion apparatus

1. A data conversion training apparatus comprising:
a training unit that trains a converter that converts conversion source data into data having an attribute indicated by an attribute code, using the conversion source data and the attribute code as an input, based on pieces of conversion source data having different attributes and attribute codes indicating attributes of the pieces of conversion source data,
the training unit training the converter so as to minimize a value of a learning criterion represented using:
regarding data converted by the converter using a given attribute code as an input, a degree of likeness to the given attribute code and a degree of likeness to converted data discerned by an integrated discriminator that discerns a degree of likeness to real data and an attribute code, and a degree of likeness to converted data; and
a difference between data re-converted by the converter, using an attribute code of conversion source data as an input, from data converted by the converter, using an attribute code different from an attribute code of the conversion source data as an input, and the conversion source data, and
the training unit training the integrated discriminator so as to minimize a value of a learning criterion represented using:
a degree of likeness to converted data, discerned by the integrated discriminator, regarding data converted by the converter using a given attribute code as an input; and
a degree of likeness to an attribute code of the conversion source data, discerned by the integrated discriminator, regarding the conversion source data.

2. The data conversion training apparatus according to claim 1,
wherein the learning criterion for the converter is represented additionally using
a distance between the data converted by the converter using the attribute code of the conversion source data as an input, and the conversion source data.

3. The data conversion training apparatus according to claim 1 or 2, wherein the data is a series of acoustic features of voice signals.

4. A data conversion apparatus comprising:
a data conversion unit that estimates target data, from input conversion source data and an attribute code indicating an attribute of the target data, using a converter that uses data and an attribute code as an input to convert the data to data having the attribute indicated by the attribute code,
wherein the converter is trained in advance based on pieces of conversion source data having different attributes and attribute codes indicating attributes of the pieces of conversion source data, so as to minimize a value of a learning criterion represented using:
regarding data converted by the converter using a given attribute code as an input, a degree of likeness to the given attribute code and a degree of likeness to converted data discerned by an integrated discriminator that discerns a degree of likeness to real data and an attribute code, and a degree of likeness to converted data; and
a difference between data re-converted by the converter, using an attribute code of conversion source data as an input, from data converted by the converter, using an attribute code different from an attribute code of the conversion source data as an input, and the conversion source data, and
the integrated discriminator is trained in advance so as to minimize a value of a learning criterion represented using:
a degree of likeness to converted data, discerned by the integrated discriminator, regarding data converted by the converter using a given attribute code as an input; and
a degree of likeness to an attribute code of the conversion source data, discerned by the integrated discriminator, regarding the conversion source data.

5. A data conversion training method comprising:
by using a training unit, training a converter that converts conversion source data into data having an attribute indicated by an attribute code, using the conversion source data and the attribute code as an input, based on pieces of conversion source data having different attributes and attribute codes indicating attributes of the pieces of conversion source data,
wherein the converter is trained so as to minimize a value of a learning criterion represented using:
regarding data converted by the converter using a given attribute code as an input, a degree of likeness to the given attribute code and a degree of likeness to converted data discerned by an integrated discriminator that discerns a degree of likeness to real data and an attribute code, and a degree of likeness to converted data; and
a difference between data re-converted by the converter, using an attribute code of conversion source data as an input, from data converted by the converter, using an attribute code different from an attribute code of the conversion source data as an input, and the conversion source data, and
the integrated discriminator is trained so as to minimize a value of a learning criterion represented using:
a degree of likeness to converted data, discerned by the integrated discriminator, regarding data converted by the converter using a given attribute code as an input; and
a degree of likeness to an attribute code of the conversion source data, discerned by the integrated discriminator, regarding the conversion source data.

6. A program for causing a computer to train a converter that converts conversion source data into data having an attribute indicated by an attribute code, using the conversion source data and the attribute code as an input, based on pieces of conversion source data having different attributes and attribute codes indicating attributes of the pieces of conversion source data,
wherein the converter is trained so as to minimize a value of a learning criterion represented using:
regarding data converted by the converter using a given attribute code as an input, a degree of likeness to the given attribute code and a degree of likeness to converted data discerned by an integrated discriminator that discerns a degree of likeness to real data and an attribute code, and a degree of likeness to converted data; and
a difference between data re-converted by the converter, using an attribute code of conversion source data as an input, from data converted by the converter, using an attribute code different from an attribute code of the conversion source data as an input, and the conversion source data, and
the integrated discriminator is trained so as to minimize a value of a learning criterion represented using:
a degree of likeness to converted data, discerned by the integrated discriminator, regarding data converted by the converter using a given attribute code as an input; and
a degree of likeness to an attribute code of the conversion source data, discerned by the integrated discriminator, regarding the conversion source data.
